(19) United States
(12) Patent Application Publication
(10) Pub. No.: US 2013/0068255 A1
(43) Pub. Date: Mar. 21, 2013

(54) Automated dust collection system

(71) Applicant: Charles E. HEGER, Saratoga, CA (US)

(72) Inventor: Charles E. HEGER, Saratoga, CA (US)

(73) Assignee: Heger Research LLC, Saratoga, CA (US)

(21) Appl. No.: 13/428,748

(22) Filed: Mar. 23, 2012

Related U.S. Application Data
(60) Provisional application No. 61/536,355, filed on Sep. 19, 2011.

(51) Int. Cl. A47L 5/00; B08B 5/04

(52) U.S. Cl. 134/18; 15/319

(57) ABSTRACT

Apparatus, methods and systems for controlling a dust collecting system are presented. A system includes a plurality of sensors paired to a corresponding plurality of blast gates, and a controller coupled to receive a signal from each of the plurality of blast gates. The sensor non-invasively detects power flow through a tool's power cord. The controller is coupled between a collector and the blast gates. The blast gates may be configured in a star and/or daisy-chained configuration allowing for flexible installation. The controller instructs the collector to turn on and off based on a sensor signal received via a corresponding blast gate.

### CROSS-REFERENCE TO RELATED APPLICATIONS

This application claims the benefit of and priority to U.S. Provisional Patent Application 61/536,355, titled “Automated Dust Collection System” to inventor Charles E. Heger and filed on Sep. 19, 2011.

### BACKGROUND

1. Field of the Invention

This disclosure relates generally to apparatus and methods for dust collection. More particularly, the disclosure relates to an automated dust collection system scaled for operation in a small shop, such as a woodshop.

II. Background

Many woodworking shops have central dust collection systems to help maintain a clean and healthy environment. With multiple machines connected to a single dust collector, it is essential that only those machines in current use be actively connected to the dust collector. Otherwise a much larger dust collector would be required to handle all the airflow from all the various machines. This is typically accomplished by means of a “blast gate.” A blast gate is a shutter-type valve associated with each tool that can close off the duct connecting a particular tool to a central dust collector or fan via the ductwork.

In operation, the user must open the required blast gate, turn on the dust collector and then proceed to turn on the tool and do whatever operation is needed such as sawing, jointing, etc. After the task is completed, the reverse actions must take place. That is, the tool is powered down, the dust collector turned off and finally the blast closed. Unfortunately, the user may forget to turn on the blast gate before use or to turn off the blast gate after use.

U.S. Pat. No. 6,012,199 issued Jan. 11, 2000, discloses a refuse vacuum system including sensors, blast gates and a controller. A central controller communicates with a sensor and a blast gate at a particular machine whereby the sensor signals the controller of the activity of the particular machine and the controller in turn communicates with the blast gate to open the blast gate. This system architecture thus requires dedicated communications links from each sensor and blast gate pair to the controller. This requirement significantly adds to the complexity of the installation wiring.

U.S. Pat. No. 7,146,677 issued Dec. 12, 2006, discloses an energy saving vacuum system utilizing variable power to a dust collector that is responsive to calculated airflow requirements. While advantageous for large installations with many machines, the cost of such a system is prohibitive for small shops having only a few machines.

Thus what is needed is a system to automatically turn on and turn off a dust collection system without the need for direct user interaction and having ease of installation.

### BRIEF SUMMARY

Disclosed are apparatus, methods and systems for operating a dust collection system. According to some aspects, disclosed is a system for operating a dust collection system the system comprising: a sensor; a blast gate coupled to receive a signal from the sensor; and a controller coupled to receive a signal from the blast gate, wherein the controller is coupled between a dust collector and the blast gate to communicate signals; wherein the blast gate communicates with the controller in a pseudorandom manner.

According to some aspects, disclosed is a system for operating a dust collection system the system comprising: a sensor; a blast gate paired to the sensor and coupled to receive a signal from the sensor; and a controller coupled to receive a signal from the blast gate; wherein the controller couples between a collector and the blast gate; and wherein the controller is for sending a signal to the collector.

According to some aspects, disclosed is a method in a blast gate for operation in a dust collection system, the method comprising: receiving, at the blast gate, an indication from a sensor non-invasively sensing power of a tool energizing status; sending, from the blast gate, a signal to a controller in response to the signal from the sensor; and actuating the blast gate in response to the signal from the sensor.

According to some aspects, disclosed is a blast gate for operation in a dust collection system, the blast gate comprising: means for receiving an indication from a sensor non-invasively sensing power of a tool energizing status; means for sending a signal to a controller in response to the signal from the sensor; and means for actuating the blast gate in response to the signal from the sensor.

It is understood that other aspects will become readily apparent to those skilled in the art from the following detailed description, wherein it is shown and described various aspects by way of illustration. The drawings and detailed description are to be regarded as illustrative in nature and not as restrictive.

### BRIEF DESCRIPTION OF THE DRAWINGS

FIG. 1 shows a typical wiring for a system installation, in accordance with some embodiments of the present invention.

FIG. 2 shows a sensor, in accordance with some embodiments of the present invention.

FIG. 3 shows an electronic design of a sensor, in accordance with some embodiments of the present invention.

FIG. 4 shows a blast gate, in accordance with some embodiments of the present invention.

FIG. 5 shows a detailed block diagram of a blast gate controller, in accordance with some embodiments of the present invention.

FIG. 6 shows a system controller, in accordance with some embodiments of the present invention.

FIG. 7 shows a detailed block diagram of a system controller, in accordance with some embodiments of the present invention.

FIG. 8 shows the structure of the pseudo-random signal generated by firmware in microcontroller 204 of the gate controller in the gate 200, in accordance with some embodiments of the present invention

FIG. 9 shows a block diagram of a system using a daisy-chain current modulation architecture, in accordance with some embodiments of the present invention.

### DETAILED DESCRIPTION

The detailed description set forth below in connection with the appended drawings is intended as a description of various aspects of the present disclosure and is not intended to represent the only aspects in which the present disclosure may be practiced. Each aspect described in this disclosure is provided merely as an example or illustration of the present disclosure, and should not necessarily be construed as preferred or advantageous over other aspects. The detailed description includes specific details for the purpose of providing a thorough understanding of the present disclosure. However, it will be apparent to those skilled in the art that the present disclosure may be practiced without these specific details. In some instances, well-known structures and devices are shown in block diagram form in order to avoid obscuring the concepts of the present disclosure. Acronyms and other descriptive terminology may be used merely for convenience and clarity and are not intended to limit the scope of the disclosure.

In some embodiments, the system includes a sensor, a blast gate, a controller and a collector. The collector may be conveniently referred to as a dust collector. The collector, or dust collector, may collect dust, sawdust, metal shavings, vapor, exhaust, steam, shaving, chips or the like. The system automates the actions of opening and closing the blast gate and energizing and de-energizing the collector fan. A sensor at each tool signals when a particular tool has been turned on. In response, the blast gate associated with that tool opens and the collector is energized. After the operation has been completed and the tool turned off, the collector is automatically turned off and the blast gate closed. The tool may be a drill, a band saw, a planar or similar tool that generates dust such as wood dust or metal shavings.

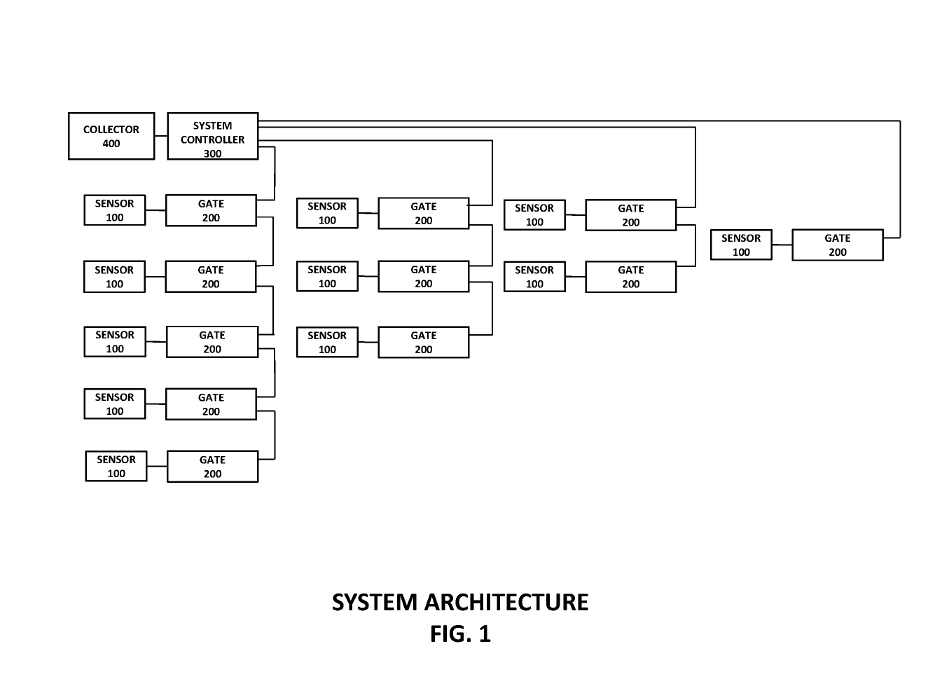

FIG. 1 shows a typical wiring for a system installation, in accordance with some embodiments of the present invention. Typically, daisy-chained gates reside along a common duct line. Ducting generally follows a main line with ducting drops to various tools. Network connections and cabling may follow and be routed along the ducting layout. The system architecture includes a collector 400 coupled to a system controller 300, which is in turn coupled to at least one gate 200. Each gate 200, also referred to as a blast gate 200, is coupled to a sensor 100.

In this embodiment, the system controller 300 includes at least four network jacks allowing up to four cables to fan out to the various blast gates 200, and each blast gate 200 has two jacks allowing a daisy-chain of gates 200 further away from the system controller 300. The embodiment shown includes four gates 200 directly coupled to the system collector 300. The first gate 200 is coupled to a sequence of four more gates 200 in daisy chain fashion. The second gate 200 is couple to two additional gates 200 and the third gate 200 is coupled to one additional gate. The final gate 200 is not coupled to an additional gate. Each gate 200 is also shown paired to an individual sensor 100.

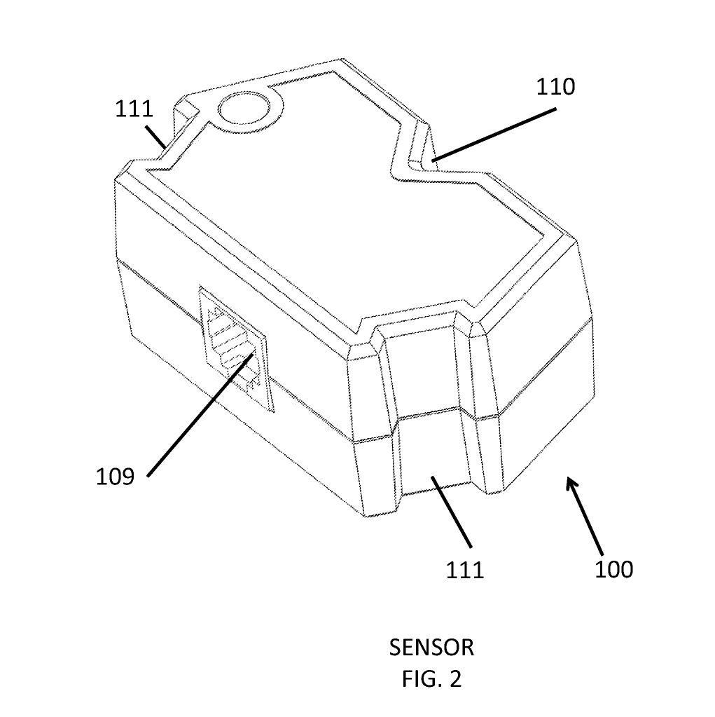

FIG. 2 shows a sensor 100, in accordance with some embodiments of the present invention. The sensor 100 is coupled between a tool (e.g., a wood saw) and blast gate 200. The sensor 100 detects current flowing in the power tool's power cord and signals the associated blast gate. In turn, the blast gate signals the system controller 300, which then energizes the collector 400 or dust collector.

The sensor 100 includes a jack 109 for use with a pre-made plug-and-play cable. In some embodiments, all system parts are connected with pre-made plug-and-play cables. For example, a system may use standard telephone connectors (RJ-12) or computer-type connectors (RJ-45) with standard communication cables. The sensor 100 also includes a V-notch 110 (which is positioned to align with a tool's power cord) and side notches 111 (which position a fastener to hold the tool's power cord against the sensor 100. The sensor 100 mechanically attaches to the power cord of the tool. For example, the V-notch 110 on the case of the sensor 100 is placed onto the power cord and a spring, rubber band, VELCRO® brand hook and loop fasteners, or other suitable retainer is hooked over the cord and into the side notches 111 of the case. Unlike other sensors, the sensor 100 passively senses the current in the power cord without breaking the electrical connection, as other sensors actively connect to the machine's wiring or enter the machine's wiring enclosures, for example, if a toroid current sensor were used. This passive arrangement significantly eases the installation and minimizes safety concerns.

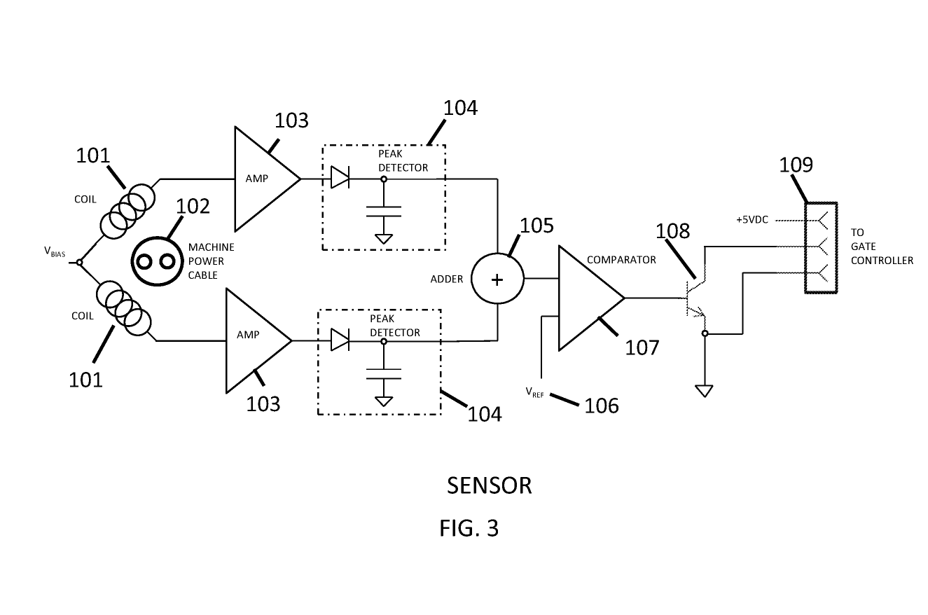

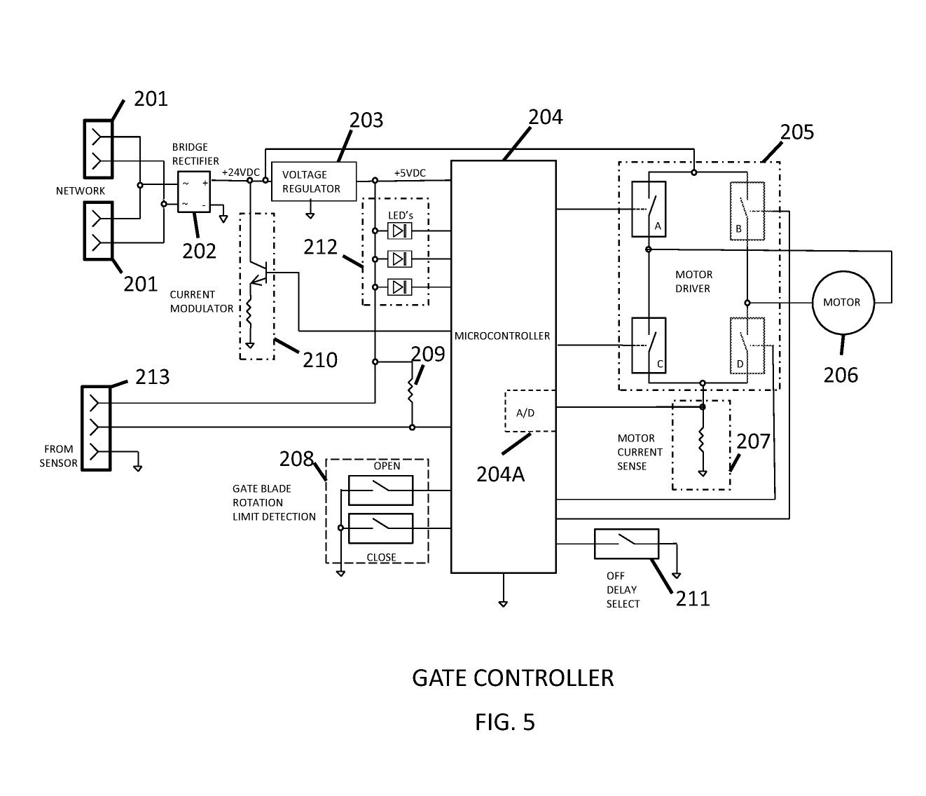

FIG. 3 shows an electronic design of a sensor 100, in accordance with some embodiments of the present invention. For additional details, see U.S. Pat. No. 7,714,567 issued May 11, 2010, titled “Power cable magnetic field sensor” to Charles E. Heger, the entirety of is incorporated herein by reference. In some embodiments, the sensor 100 is powered from the gate 200. Furthermore, two magnetic coils 101 are physically arranged such that they are orthogonal to each other and to the axis of the machine or tool's power cable 102 (not part of the sensor 100). The orthogonal coils 101 along with amplifiers 103 detect stray magnetic field generated due to current flowing when the machine or tool is energized. The outputs of both amplifiers are detected by peak detectors 104 comprising a diode coupled in series and a capacitor coupled in parallel. In this matter, the orthogonal coils 101, amplifiers 103 and peak detectors 104 act as a detector of current flowing in the tool's power cable. The resultant DC level from both detectors 104 is summed by adder 105. The resultant sum is compared against reference value or reference voltage 106 (V_{REF}) by comparator 107 and if the sum exceeds reference voltage 106, the comparator 107 will energize open collector output transistor 108. The open collector/open drain transistor 108 writes an output signal, which is provided to the gate 200. Upon detection of power to the tool, the transistor 108 is turned on establishing a low impedance logic level. A corresponding resistive pull-up current source in the gate 200 (see resister 209 in FIG. 5) established a high level. This signal, in turn, will signal the gate 200. For manual operations such as bench and floor sweeps, the sensor 100 may be replaced or supplemented with an accessory switch to control the gate 200 and collector 300. For example, when turned on, the switch establishes the logic low level thus activating the gate 200.

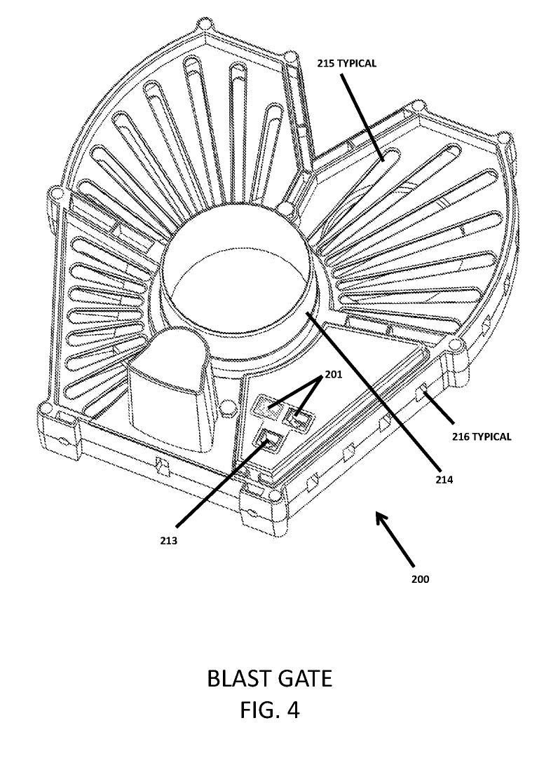

FIG. 4 shows a blast gate 200, in accordance with some embodiments of the present invention. A blast gate 200 includes a motor and is coupled between a sensor 100 and a system controller 300, as described above.

In the embodiment shown, the motorized blast gate 200 couples to standard four-inch ducting. A blast gate 200 is placed interrupting in the ducting at each tool or machine. A blade, such as a rotating blade pivoting about a post, opens and closes the duct line. There are identical four-inch duct flanges 214 on both sides of the gate 200 with tapers and a stepped section to allow connection to a broad variety of duct work. A plurality of slots 215 in the gates allow a visual check of blast gate operation as well as keeping possible debris buildup minimized Sawdust ports 216 are arranged around the perimeter to allow any captured or accumulated debris to exit. The gate 200 also includes one two-wire connector 201 to couple the gate 200 to the controller 300. Alternatively, the gate 200 includes two two-wire connectors 201 for daisy chaining a sequence of gates 200. That is, the connectors 201 allow a gate 200 to couple to upstream gates 200 towards the controller 300 and to additional downstream gates 200.

After receiving a signal from the sensor 100, the blast gate 200 opens to allow a vacuum to suck debris from the tool to the collector 400. In some embodiments, the gate 200 provides a short delay to allow the blast gate 200 to partially complete opening, and then the blast gate 200 signals the controller 300 to start the collector 400. This short delay reduces the possibility of a high vacuum condition in the duct work. In other embodiments, the gate 200 waits to signal the controller 300 until the blast gate 200 is entirely open. In this manner, a high vacuum condition is avoided.

FIG. 5 shows a detailed block diagram of a blast gate controller within the gate 200, in accordance with some embodiments of the present invention. A two-wire connector 201, which is coupled to the system controller 300, is energized with 24 VDC. This voltage is connected to bridge rectifier 202 allowing the voltage from the controller 300 to be of positive or negative polarity. The universal polarity guarantees any cable may be used regardless of the actual connector makeup. In some embodiments, there are two network connectors 201, both identical, allowing the system wiring to be daisy-chained from gate to gate, as described above. Typically, there is a central trunk duct from which individual tools or machines are teed. Daisy chaining allows a single network line to be started at the master controller 300 and to extend to the farthest gate on the main duct line. The rectified 24VDC from the bridge rectifier 202 is regulated by regulator 203 providing 5 VDC for a microcontroller 204 and LEDs 212. Additionally, the 24VDC provides power for the motor 206 via motor controller 205. A resister 209 provides a pull-up current source for open collector transistor 108 in the sensor 100.

The microcontroller 204 monitors the signal from a sensor 100 connected to connector 213 and upon receipt of a low logic level from the sensor 100, the microcontroller 204 energizes blast gate motor 206 via motor driver 205 with a polarity such that the blast gate blade rotates to open and thus establishing a passage through the blast gate 200. Motor driver 205 is comprised of four electronic switches. The polarity of the voltage energizing the motor is dependent upon which switches are activated. Turning on switches 205A and 205D, for example, will drive the motor in one direction. Activating switches 205B and 205C will cause the reverse rotation to occur. Motor braking can be caused by activating switched 205C and 205D effectively shorting the motor resulting in rapidly stopping its rotation without excess coasting. This braking ensures the position of the blade will be constant and repeatable when the blade is in the open position and the closed position following detection by a blade-rotation-limit switches 208. In some embodiments, the blade-rotation-limit switches 208 are switched using magnetic sensing, such as with reed switches or Hall-affect sensors. Magnets may be used within the blade rotor such that the magnets set the appropriate open or close rotation position of the blade.

Motor current is monitored with resistor 207 and subsequently monitored by microcontroller 204 via A/D converter 204A. Should the motor current exceed a preset level as defined by firmware indicating a possible blast gate jam, microcontroller 204 will de-energize motor 206. A short delay is incorporated in the firmware to ignore the initial high start current of motor 206 upon motor activation. The microcontroller 204 may allow a short delay, which allows the blast gate to partially open, or may allow a longer delay, which allows the blast gate to fully open. The microcontroller 204, via a current modulator 210, generates a pseudo random current modulated signal impressed on the network wiring.

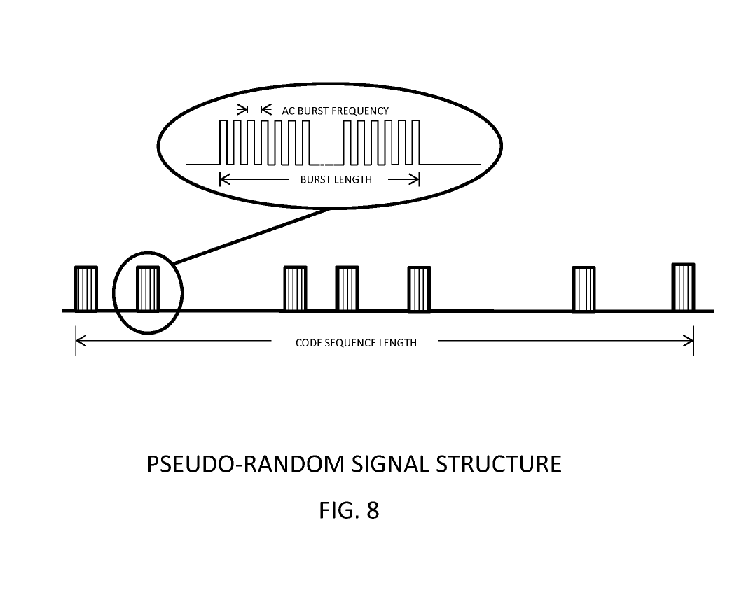

In some embodiments, blast gate signals sent from the blast gate 200 to the controller 300 are communicated with current modulation placed on the power line supplying voltage to the gates 200. Current modulation is a low impedance signaling method that is robust and highly immune to extraneous electrical noise sources such as those generated by motors, light ballasts and the like. In some embodiments, the blast gate signal is identical in structure to signals coming from each blast gate 200. To help guarantee there will be no signal cancellation due to additive out-of-phase addition should more than one blast gate 200 be simultaneously signaling controller 200, the blast gate signal structure may be a pulsed burst, for example between 1 kHz to 20 kHz AC with the bursts having 10 to 200 cycles and being pseudo randomly timed. The statistical chance of any two signals from two gates aligning exactly to produce phase cancellation is very remote. The blast gate signal is further described below with reference to FIG. 8.

In some embodiments, the blast gate 200 has a user-selectable turn-off delay time that may be selected with switch 211. A short turn-off delay is used where a machine, such as a table saw or jointer, is typically turned on for a minute or more with longer intervals between uses. Alternatively, a longer delay of several minutes may be selected allowing the collector to run without constantly cycling off and back on during repetitive, short cycle time operations such as chop sawing. This reduces excess cycling to the dust collector fan motor.

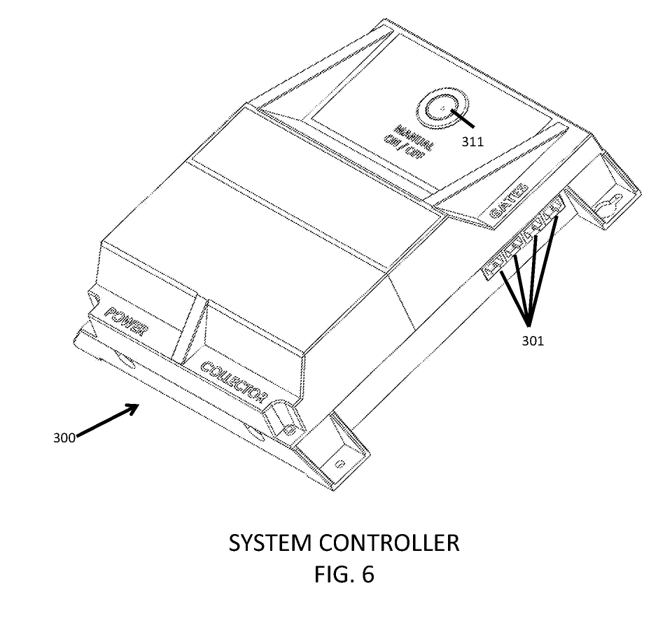

FIG. 6 shows a system controller 300, in accordance with some embodiments of the present invention. The system controller 300 is coupled between one or more blast gates 200 and a collector 400. In the embodiment shown, the system controller 300 includes a manual on/off switch, a power to accept power, a port to enable and disable the collector 300, and four connectors to couple one or more daisy-changed gates 200.

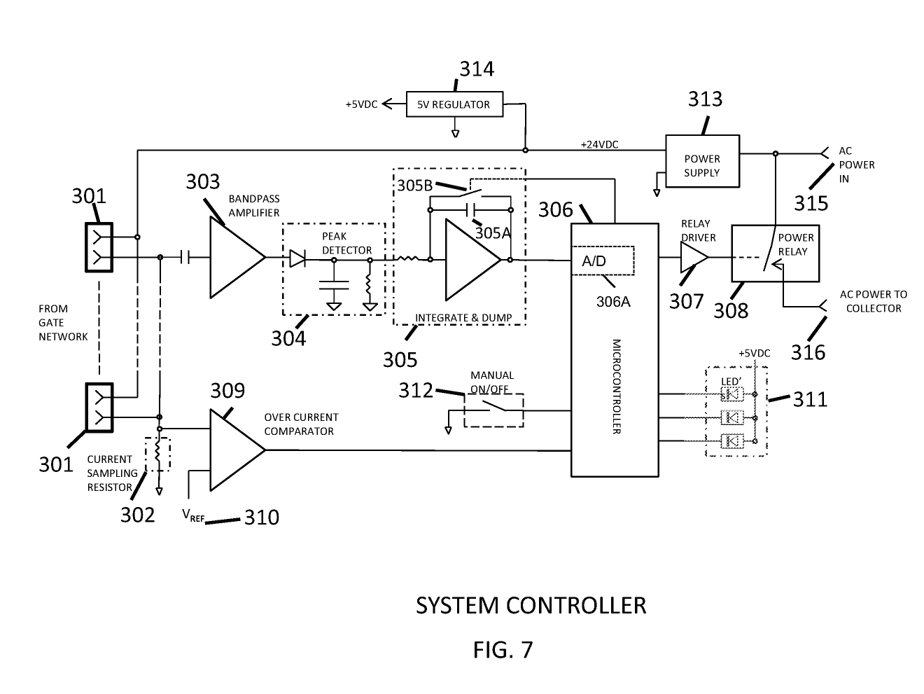

FIG. 7 shows a detailed block diagram of a system controller 300, in accordance with some embodiments of the present invention. As explained above, the blast gates 200 are wired to the system controller via connectors 301. In some embodiments, there are four network connectors 301, all identical and wired in parallel, allowing up to four network lines to fan out to various blast gates. A power supply 313 provides 24 VDC power to the blast gates 200 and voltage regulator 314. The voltage regulator 314 provides a regulated 5 VDC. Current being used by the blast gates 200 flows through a current sampling resistor 302, which is coupled to one of the two-wire input lines of each connector 301. The total current being supplied by the gates 200 includes current from any static gates in the controller in the gate 200, blast gate motor 206, and any sensor or pseudo-random signaling current modulation.

A bandpass amplifier 303 is also coupled to one of the two-wire input lines of each connector 301. The bandpass amplifier 303 is AC coupled to sense an AC signal from the network current. The bandpass frequency of the bandpass amplifier 303 may be selected to be the same as a frequency of a square wave current modulation signal (described below with reference to FIG. 8) generated by the gate controllers in the gates 200. The output of the bandpass amplifier 303 provides a filtered signal of any burst of AC passed to the bandpass amplifier. The output of the bandpass amplifier 303 is fed to a peak detector 304. The resultant pulses of DC corresponding to the modulated AC burst envelopes are integrated by integrate-and-dump (I/D) circuit 305. The I/D circuit 305 may be allowed to integrate 1 to 5 times the length of the pseudorandom signal code. At the end of this integration time, the microcontroller 306 measures the accumulated integrated voltage from the I/D circuit 305 via an A/D converter 306A and compares the resultant value against a firmware established threshold. The I/D circuit 305 then is reset by discharging the integration capacitor 305A by closing electronic switch 305B which can be a bipolar or MOS transistor. The controller 300 also includes a power relay 308, which has incoming AC power 315 available. If the resultant voltage from the I/D circuit 305 exceeds a firmware threshold, the power relay 308 may be activated via relay driver 307 resulting in AC power 316 being applied to the collector fan 400. If all tool sensors 200 detect no machine activity, the output signal of the I/D circuit 305 will not exceed a firmware threshold. The microcontroller 306, after a possible short delay to allow the duct line to clear of debris, turns off the power relay 308 thus turning off the collector fan 400.

The current flowing in all the network connections 301 is monitored by the current-sampling resistor 302 in the controller 300. The current-sampling resistor 302 senses the pseudo-random signal and also senses the DC level current level. Should this level exceed a threshold established by V_{REF} 310, a comparator 309 may change output logic levels. The microcontroller 306 may then respond by enabling an LED 311 associated with an error condition to alert the operator. In some embodiments, this over current condition can be used to disconnect the gate network from the 24 VDC voltage source via an electronic switch (not shown) such as a power bipolar or MOS transistor. The detected error would then cease whereon the microcontroller may re-establish power to the gates. This condition may continue to cycle at a rate determined by the microcontroller firmware until such time as the overload condition was resolved.

A manual switch 312 is included on the master controller to allow turning on of the dust collector without any machine being on. In some embodiments, the LEDs 311 may indicate: (1) POWER; (2) SENSING (when a tool is on or off); and (3) ERROR (when the network cabling power is overloaded or shorted).

FIG. 8 shows the structure of the pseudo-random signal generated by firmware in microcontroller 204 of the gate controller in the gate 200, in accordance with some embodiments of the present invention. A maximal length linear sequence code is used as described in “Spread Spectrum Systems”, 2^{nd} Edition, Robert C. Dixon, pp. 58-91. In some embodiments, a 4-bit code is used having a run length of 2⁴−1 or 15 unique states. Although a longer code length could be used, little statistical improvement in phase cancellation would be realized with longer codes.

In some embodiments, a unique pseudo-random code can be used for each sensor/blast gate pair in the system. The user would select a unique setting at the blast gate 200 much like choosing the code on a garage opener. This would allow activities such as data logging and airflow adjustment, etc. The system controller 300 would then have firmware to synchronize and uniquely identify various codes present much like a GPS receiver decodes various satellite signals.

The microcontroller-generated pseudo-random sequence is used to turn phase modulator 210 of the controller in the gate 200 on and off. The phase modulator forms a constant current source with the current level established by the voltage on the base of the transistor and the resistor value in the emitter. Using a current source rather a simple transistor switch with a resistor in the collector ensures a consistent current modulation level regardless of variations in the incoming 24 VDC from the system controller.

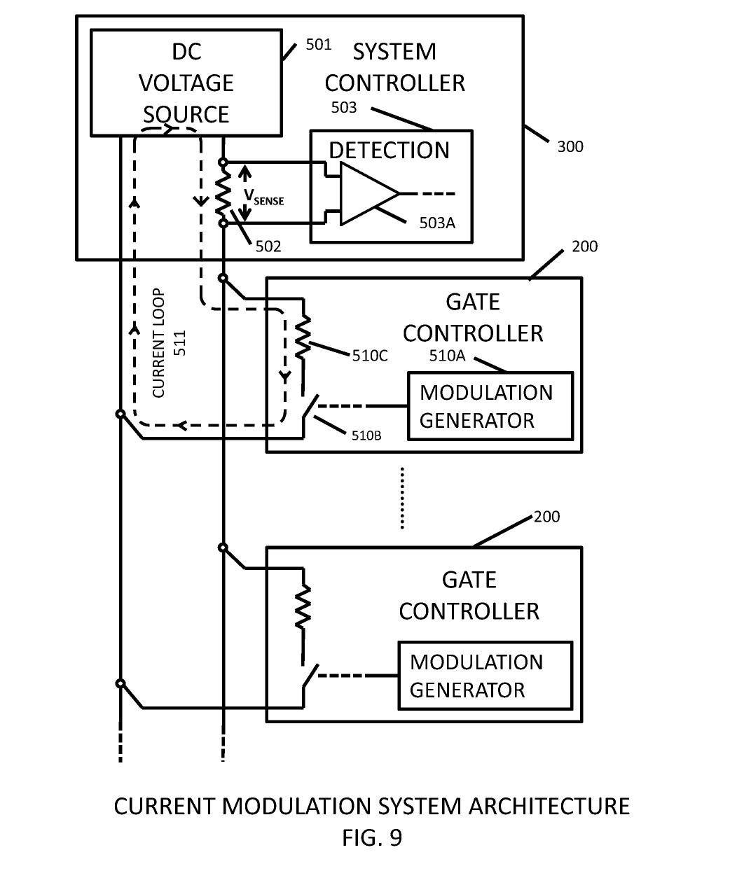

FIG. 9 shows a block diagram of a system using a daisy-chain current modulation architecture, in accordance with some embodiments of the present invention. A DC voltage source 501 is part of a system controller 300 that supplies power to a series of daisy-chained blast gates 200. Any number of gates 200 may be connected dependent on the voltage source current capability.

Each blast gate 200 contains a modulation generator 510A. This generator produced a time varying signal which in turn controls the switch 510B. If switch 510B is open, no additional current will flow in current loop 511. If switch 510B is closed, current flows in loop 511 with the current established by resistor 510C and the value of voltage source 501. A time varying differential is used to distinguish a signal from a static DC current required to power the gates. Detection circuit 503A responds only to the time varying signal and ignores the DC component of the current. The varying current is sensed across resistor 502 in system controller 300, producing a voltage which is detected by circuit 503. If multiple gates are simultaneously producing modulation, the voltage across sense resistor 502 will increase accordingly.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure.

1. A system for operating a collection system, the system comprising:
a sensor providing a sensor signal;
a blast gate paired to the sensor and coupled to receive the sensor signal from the sensor, wherein the sensor signal controls the blast gate and in response to the sensor signal to originate a collector energizing signal at the blast gate; and
a system controller coupled to receive the collector energizing signal originating from the blast gate;
wherein the system controller couples between a collector and the blast gate; and
wherein the system controller is for sending a signal to the collector.

2. The system of claim 1, wherein the sensor comprises a non-invasive sensor.

3. The system of claim 2, wherein the non-invasive sensor comprises orthogonal coils.

4. The system of claim 2, wherein the non-invasive sensor comprises detector of current flowing in a tool's power cable.

5. The system of claim 1, wherein the sensor comprises:
two magnetic coils physically arranged such that they are orthogonal to each other and to an axis of a machine's power cable;
two amplifiers each respectively coupled to the two magnetic coils to detect stray magnetic field generated due to current flowing when the machine is energized;
two peak detectors each respectively coupled to receive an output signal from the two amplifiers;
an adder coupled to the two peak detectors to sum an output signal from the two peak detectors; and
a comparator coupled to the adder to compare an output of the adder with a reference value, wherein the comparator outputs a signal to energize the blast gate when the output of the adder exceeds the reference value.

6. The system of claim 1, wherein:
the sensor comprises a plurality of sensors;
the blast gate comprises a plurality of blast gates paired respectively to the plurality of sensors and each pair coupled to receive a respective signal; and
the system controller is coupled to receive respective signals from the plurality of blast gates.

7. The system of claim 1, wherein the blast gate comprises:
a motor coupled between the sensor and the system controller;
a blade to open and close a duct line to the collector; and
a plurality of slots to allow a visual check of operation of the blast gate.

8. The system of claim 7, wherein the blast gate further comprises dust ports arranged around a perimeter to allow debris to exit.

9. The system of claim 7, wherein the blast gate further comprises a two-wire connector to couple the blast gate to the system controller.

10. The system of claim 7, wherein the blast gate further comprises:
a first wire connector to couple the blast gate to the system controller; and
a second wire connector to couple the blast gate to a second blast gate coupled to a second sensor;
wherein the system controller, the blast gate and the second blast gate are coupled in a daisy chain wherein a signal from the second sensor passes through the second blast gate to the blast gate to the system controller.

11. The system of claim 7, wherein the blast gate further comprises:
a wire connector to couple the blast gate to the system controller;
bridge rectifier coupled to the wire connector;
voltage regulator coupled to the bridge rectifier; and
a microcontroller coupled to the voltage regulator.

12. The system of claim 11, wherein the blast gate further comprises a motor driver coupled to the microcontroller, wherein the motor driver comprises four electronic switches.

13. The system of claim 1, wherein the blast gate comprises a selectable turn-off delay.

14. The system of claim 1, wherein the blast gate comprises a switch for manual operation.

15. The system of claim 1, wherein the blast gate is configured to send a pseudorandom signal to the system controller.

16. The system of claim 1, wherein the blast gate is configured to send a current modulated signal to the system controller.

17. The system of claim 1, wherein the system controller comprises:
a wire connector to couple the system controller to the blast gate;
a baseband amplifier coupled to the wire connector; and
a microcontroller coupled to the baseband amplifier.

18. The system of claim 1, wherein the collector comprises a dust collector.

19. (canceled)

20. (canceled)

21. (canceled)

22. (canceled)

23. (canceled)

24. (canceled)

25. (canceled)

26. The system of claim 12, wherein a first pair of the four electronic switches drives the motor in a first direction and wherein a second pair of the four electronic switches drives the motor in a second direction.

27. The system of claim 26, wherein a third pair of the four electronic switches causes motor braking.

28. The system of claim 13, wherein the selectable turn-off delay comprises a user selectable turn-off delay.

29. A method for operating a collection system, the method comprising:
providing, from a sensor, a sensor signal;
receiving, at a blast gate paired to the sensor, the sensor signal from the sensor, wherein the sensor signal controls the blast gate;
originating, in response to the sensor signal, a collector energizing signal at the blast gate; and
receiving, at a system controller, the collector energizing signal originating from the blast gate;
wherein the system controller couples between a collector and the blast gate; and
wherein the system controller is for sending a signal to the collector.

30. The method of claim 29, further comprising visually checking operation of the blast gate through a plurality of slots.

31. The method of claim 29, further comprising allowing debris to exit through a plurality of slots

32. The method of claim 29, further comprising selectable turning off a delay.

33. The method of claim 29, further comprising sending a pseudorandom signal to the system controller.
